(19) United States
(12) Patent Application Publication
(10) Pub. No.: US 2024/0270543 A1
(43) Pub. Date: Aug. 15, 2024

(54) MOTOR SYSTEM CABLE WINCH FOR VEHICLE

(71) Applicant: TOYOTA MOTOR ENGINEERING & MANUFACTURING NORTH AMERICA, INC., Plano, TX (US)

(72) Inventor: PAXTON S. WILLIAMS, Milan, MI (US)

(73) Assignees: TOYOTA MOTOR ENGINEERING & MANUFACTURING NORTH AMERICA, INC., Plano, TX (US); TOYOTA JIDOSHA KABUSHIKI KAISHA, Toyota-shi (JP)

(21) Appl. No.: 18/167,290

(22) Filed: Feb. 10, 2023

(51) Int. Cl. B66D 1/22; B60L 1/00; B66D 1/12; B66D 1/46

(52) U.S. Cl. CPC B66D 1/22; B60L 1/003; B66D 1/12; B66D 1/46

(57) ABSTRACT

Hybrid electric vehicles (HEVs) and electric vehicles (EVs) include one or more motor generators for providing motive force to propel such HEVs/EVs. A winch may be operatively connected to such motor generators, where selective engagement and disengagement of the winch to such motor generators is effectuated via a clutch mechanism. The speed at which the winch may be operated may be effectuated via a planetary gear mechanism. In this way, the motor generator(s) of an HEV/EV can be leveraged to power the winch.

### TECHNICAL FIELD

The present disclosure relates generally to hybrid electric vehicles (HEVs) and electric vehicles (EVs), and in particular, some implementations may relate to integrating motor system cable winch for HEVS/EVs.

### DESCRIPTION OF RELATED ART

Winches may sometimes be utilized with trucks or off-road vehicles for extracting such trucks/off-road vehicles from certain situations. For example, when an off-road vehicle is stuck due to muddy driving conditions in an off-road environment, a winch may be used to connect the off-road vehicle to an anchor point. The winch may then be engaged to extract the off-road vehicle from the mud.

### BRIEF SUMMARY OF THE DISCLOSURE

In accordance with one embodiment, a vehicle comprises a motor generator, a clutch, a power split device, and a winch connected to the motor generator via the clutch and the power split device. The clutch is operative to selectively engage or disengage the winch assembly from the motor generator. The power split device is operative to control speed of operation of the winch.

In some embodiments, the power split device comprises a planetary gear.

In some embodiments, the vehicle further comprises a winch control component operative to control the selective engagement or disengagement of the clutch.

In some embodiments, the winch control component is further operative to receive user input directing the operation of the power split device to control the speed of operation of the winch.

In some embodiments, the winch comprises a rotating member to which a cable is connected, the rotating member effectuating the directed operation of the power split device.

In some embodiments, the vehicle further comprises a cable guide through which the cable operatively connected to the rotating member is routed.

In some embodiments, the vehicle further comprises a second motor generator, a second clutch, a second power split device, and a second winch connected to the second motor generator via the second clutch and the second power split device. The second clutch is operative to selectively engage or disengage the second winch assembly from the second motor generator, and the second power split device is operative to control speed of operation of the second winch.

In some embodiments, the second power split device comprises a second planetary gear.

In some embodiments, the winch control component is operative to control the selective engagement or disengagement of the second clutch.

In some embodiments, the winch control component is further operative to receive additional user input directing the operation of the second power split device to control the speed of operation of the second winch.

In some embodiments, the second winch comprises a second rotating member to which a second cable is connected, the second rotating member effectuating the directed operation of the second power split device.

In some embodiments, the vehicle further comprises a second cable guide through which the second cable operatively connected to the rotating member is routed.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1A is a first view of an example conventional winch attached to a vehicle.

FIG. 1B is a second view of the example conventional winch of FIG. 1A.

FIG. 2 is a schematic representation of an example vehicle with which embodiments of the systems and methods disclosed herein may be implemented.

FIG. 3 is a schematic representation of a motor system cable winch in accordance with one embodiment of the technology disclosed herein.

FIG. 4 is an example computing component that may be used to implement various features of embodiments described in the present disclosure.

The figures are not exhaustive and do not limit the present disclosure to the precise form disclosed.

### DETAILED DESCRIPTION

As alluded to above, winches may be used with trucks or off-road vehicles to extract such trucks/off-road vehicles from hazardous or non-ideal driving conditions. Winches may also be used to pull/move objects. For example, such trucks/off-road vehicles can provide at least some of the motive force needed to pull some obstacle, such as a fallen tree limb, or move the obstacle (or any object) once connected to the trucks/off-road vehicles vis-à-vis a winch.

However, conventional winches tend to be heavy, and require after-market alterations/components to facilitate installation on a vehicle, such as mounting brackets or structural reinforcements that may also be heavy/cumbersome. Conventional winches include electrical motors that use a vehicle's battery to power the electrical motors. Such electrical motors tend to be large, heavy, and cumbersome, necessitating the aforementioned large/heavy brackets that can transfer the loads from the winch cable to the vehicle's frame. The brackets can disrupt original equipment manufacturer (OEM)-intended crash deformation modes or characteristics of the vehicle, e.g., the deformation mode of crash energy absorbing components. The footprint of conventional winches can also interfere with air flow cooling through vents or other vehicular mechanisms, and in some instances, may even impact the driving or handling characteristics of the vehicle.

HEVs/EVs already include motors, e.g., motor-generators, to provide motive force for propulsion of such HEVs/EVs. Accordingly, embodiments of the disclosure technology are directed to winches that leverage the existing motors for powering a winch for extraction or retraction of the cable/rope. It should be understood that some winches may rely on manual force to extract the cable/rope, but still rely on the motor for cable/rope retraction.

In some embodiments, a winch may be operatively connected to a motor of an HEV/EV via a clutch/planetary gear mechanism that would allow a user to switch use of the motor from providing motive power to the HEV/EV to providing motive power to the winch. Because such a winch leverages the existing motor of an HEV/EV, no large/heavy mounting brackets or supporting member/structural reinforcements are needed. Moreover, due to the integration of the winch with the HEV's/EV's motor, the placement of the winch may be more discreet, and less obtrusive. Thus, the disadvantages of conventional winches regarding the potential for blocking air flow, altered handling/driving characteristics, and disruption of crash deformation modes can be mitigated or avoided altogether.

The typical winch comprises a body or housing that encapsulates a cable, rope, length of line, etc. For example, a cable can be configured to wrap around a rotating member, such as a drum as the cable is retracted/stored. In use, the cable can be fed out via the rotating member. Typically a hook or other connection point/mechanism is integrated with or attached to one end of the cable that is distal from the other end of the cable that connects to the rotating member.

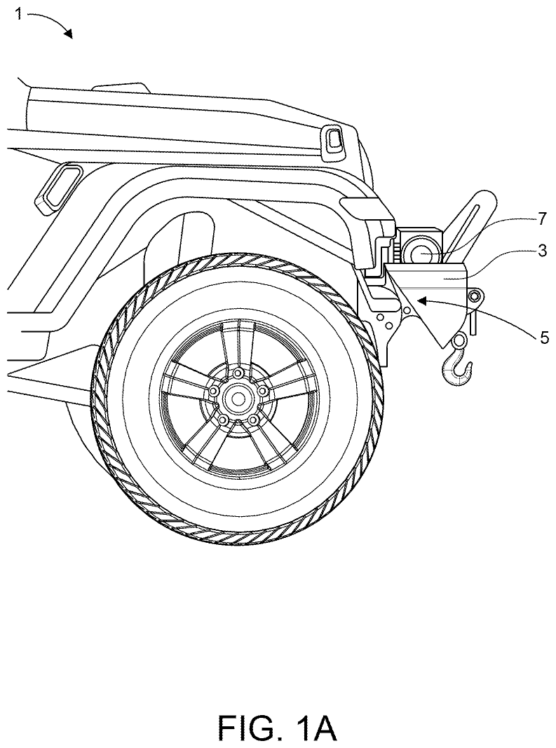

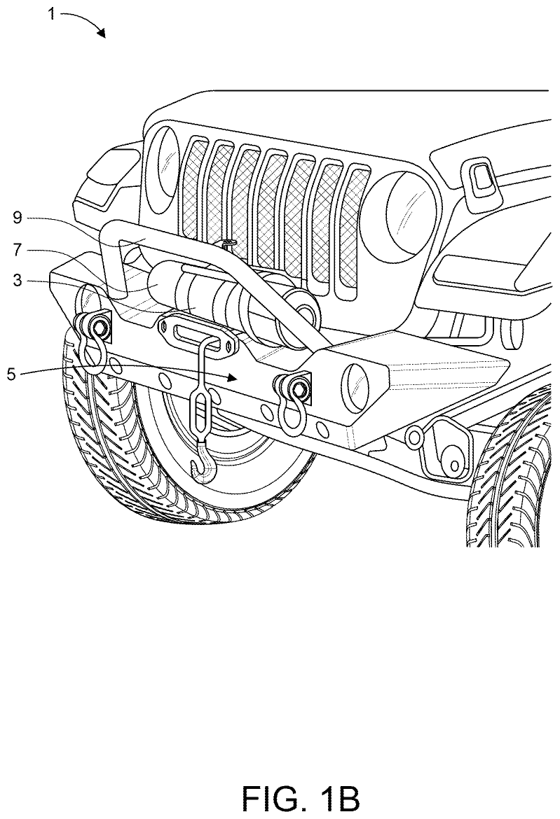

FIG. 1A is a side view of an example winch 3 that is connected to vehicle 1. As can be appreciated, and as would be understood by those of ordinary skill in the art, winches or winch assemblies can be heavy and cumbersome. For example, a motor is typically included as part of a winch to provide motive power to the rotating member for retracting or releasing/extracting a desired length of cable.

Moreover, winches or winch assemblies may further include a mounting bracket(s) or structural reinforcements (collectively referred to as “installation components”) used to operatively attach or connect the winch/winch assembly to the vehicle. For example, a mounting bracket may be used to mount a winch or winch assembly to the vehicle's frame. As alluded to above, conventional winches typically include or require the use of large, heavy installation components 5, as well as an electric motor 7. Winch 3, installation components 5, and electric motor 7, together, may comprise what can referred to as a winch assembly.

FIG. 1B illustrates a perspective view of vehicle 1 and the winch assembly comprising winch 3, installation components 5, and electric motor 7. From this perspective view, the large size of the winch assembly can be better appreciated. It can be seen that a portion of winch 3 and electric motor 7 cover a portion of the grill 1A of vehicle 1. Installation components 5, in this example winch assembly can be seen to span nearly the entirety of the front fascia of vehicle 1. Moreover, the view provided by FIG. 1B illustrates another possible aspect of the winch assembly, e.g., bumper/bar 9, which may provide protection for the winch assembly, but adds further weight, bulk, componentry.

The systems and methods disclosed herein may be implemented with or by any of a number of different vehicles and vehicle types. For example, the systems and methods disclosed herein may be used with automobiles, trucks, motorcycles, recreational vehicles and other like on-or off-road vehicles. In addition, the principles disclosed herein may also extend to other vehicle types as well.

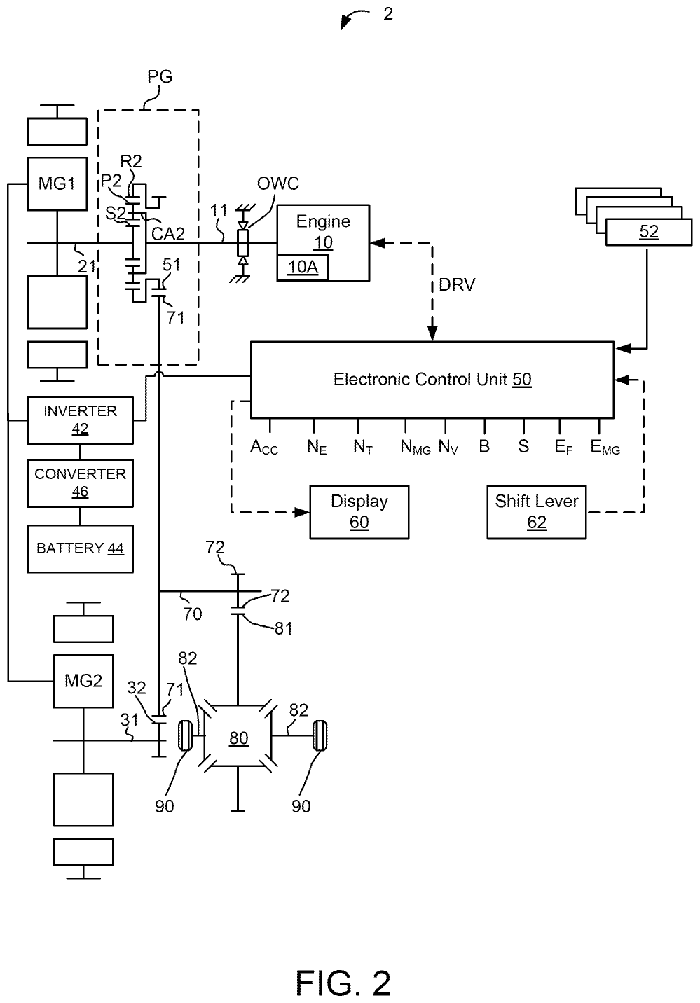

FIG. 2 is a diagram illustrating an overall configuration of a HEV 2 according to one embodiment. HEV 2 may include an engine 10, a motor generator MG1, a motor generator MG2, a power split device (planetary gear device) PG, a counter shaft (output shaft) 70, a differential gear system 80, drive wheels 90, a shift lever 62, a display unit 60, and an Electronic Control Unit (ECU) 50.

HEV 2 may be referred to as a front-engine/front-drive (FF type) hybrid vehicle which moves by using power from at least one of engine 10, motor generator MG1 and motor generator MG2. It should be understood that HEV 2 is not limited to being an FF type hybrid vehicle. For example, HEV 2 may be a front-engine/rear-drive (FR) type hybrid vehicle, as well as an all-wheel drive (AWD) hybrid vehicle. Moreover, HEV 2 may be a plug-in hybrid vehicle mounted with a battery 44 which can be charged by using an external power source (not shown).

Engine 10 may be, for example, an internal combustion engine (ICE) such as a gasoline engine or a diesel engine or similarly powered engine in which fuel is injected into and combusted in a combustion chamber. Engine 10 may be controlled by control signals from ECU 50. For example, an output control circuit 10A may be provided to control engine 10. Output control circuit 10A may include a throttle actuator to control an electronic throttle valve that controls air intake and fuel injection (as a byproduct of controlling air intake), fuel injection, an ignition device that controls ignition timing, and the like. Regarding air intake, it should be understood that generally, the throttle opens allowing air to move into the intake. ECU 50/sensors 52 may measure the airflow into the intake. ECU 50 commands the fuel injectors to output the specific amount of fuel needed to reach the target air to fuel ratio based on driving conditions and engine 10 parameters/characteristics. Output control circuit 10A may execute output control of engine 10 according to a command control signal(s) supplied from ECU 50, as described herein. Such output control can include, for example, throttle control, fuel injection control, and ignition timing control.

ECU 50 may include circuitry to control various aspects of vehicle operation. ECU 50 may include, for example, a microcomputer that includes a one or more processing units (e.g., microprocessors), memory storage (e.g., RAM, ROM, etc.), and I/O devices. The processing units of ECU 50 execute instructions stored in memory to control one or more electrical systems or subsystems in the vehicle. ECU 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., anti-lock braking system (ABS) or electronic stability control (ESC)), battery management systems, and so on. These various control units can be implemented using two or more separate electronic control units, or using a single electronic control unit.

In the example illustrated in FIG. 1A, ECU 50 receives information from a plurality of sensors included in vehicle 2. For example, ECU 50 may receive signals that indicate vehicle operating conditions or characteristics, or signals that can be used to derive vehicle operating conditions or characteristics. These may include, but are not limited to accelerator operation amount, A_{CC}, a revolution speed, NE, of engine 10 (engine RPM), a rotational speed, N_{MG1}/N_{MG2}, of motor generators MG1 and MG2, respectively (motor rotational speed), and vehicle speed, N_{V}. These may also include brake operation amount/pressure, B, steering wheel angle/rotation, S, battery SOC (i.e., the charged amount for the battery detected by an SOC sensor). Accordingly, HEV 2 can include a plurality of sensors 52 that can be used to detect various conditions internal or external to the vehicle and provide sensed conditions to ECU 50 (which, again, may be implemented as one or a plurality of individual control circuits). In one embodiment, sensors 52 may be included to detect one or more conditions directly or indirectly such as, for example, fuel efficiency, Er, motor efficiency, E_{MG1} and E_{MG2}, hybrid (engine 10+MG1 and/or MG2) efficiency, etc.

In some embodiments, one or more of the sensors 52 may include their own processing capability to compute the results for additional information that can be provided to ECU 50. In other embodiments, one or more sensors may be data-gathering-only sensors that provide only raw data to ECU 50. In further embodiments, hybrid sensors may be included that provide a combination of raw data and processed data to ECU 50. Sensors 52 may provide an analog output or a digital output.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

Motor generator MG1 and motor generator MG2 each may be a permanent magnet type synchronous motor including for example, a rotor with a permanent magnet embedded therein. A rotation shaft 21 of motor generator MG1 may be disposed coaxially with a crank shaft 11 of engine 10. A rotation shaft 31 of motor generator MG2 may be disposed parallel to rotation shaft 21 of motor generator MG1. Counter shaft (output shaft) 70 may be disposed parallel to rotation shaft 21 of motor generator MG1 and rotation shaft 31 of motor generator MG2.

Motor generator MG1 and motor generator MG2 may each be driven by an inverter 42. The inverter 42 may be controlled by a control signal from ECU 50 so as to convert direct current (DC) power from battery 44 to alternating current (AC) power, and supply the AC power to motor generators MG1 and MG2. Motor generator MG2 may be driven by electric power generated by motor generator MG1. It should be understood that in embodiments where motors MG1, MG2 are DC motors, no inverter is required. The inverter, in conjunction with a converter assembly 46 may also accept power from one or more of motor generators MG1, MG2 (e.g., during engine charging), convert this power from AC back to DC, and uses this power to charge battery 44 (hence the name, motor generator). ECU 50 may control the inverter, adjust driving current supplied to motor generator MG2, and adjust the current received from motor generator MG1 during regenerative coasting and braking.

Battery 44 may be implemented as one or more batteries or other power storage devices including, for example, lead-acid batteries, lithium ion, and nickel batteries, capacitive storage devices, and so on. Battery 44 may also be charged by one or more of motor generators MG1, MG2 such as, for example, by regenerative braking or by coasting during which one or more of motor generators MG1, MG2 operates as generator. Alternatively (or additionally, battery 44 can be charged by motor generator MG1, for example, when HEV 2 is in idle (not moving/not in drive). Further still, battery 44 may be charged by a battery charger (not shown) that receives energy from engine 10. The battery charger may be switched or otherwise controlled to engage/disengage it with battery 44. For example, an alternator or generator may be coupled directly or indirectly to a drive shaft of engine 10 to generate an electrical current as a result of the operation of engine 10. Still other embodiments contemplate the use of one or more additional motor generators to power the rear wheels of a vehicle (e.g., in vehicles equipped with 4-Wheel Drive), or using two rear motor generators, each powering a rear wheel.

Battery 44 may also be used to power other electrical or electronic systems in the vehicle. Battery 44 can include, for example, one or more batteries, capacitive storage units, or other storage reservoirs suitable for storing electrical energy that can be used to power motor generator MG1 and/or motor generator MG2. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

Power split device PG can refer to planetary gear device, such as a single pinion type planetary gear device, which may include a sun gear S2, a pinion gear P2, a ring gear R2 and a carrier CA2. Carrier CA2 of power split device PG may be coupled to crankshaft 11 of engine 10. Pinion gear P2 may be disposed between sun gear S2 and ring gear R2, meshing with sun gear S2 and ring gear R2, respectively. Pinion gear P2 may be supported by carrier CA2, capable of undergoing rotation and revolution. Sun gear S2 may be coupled to rotation shaft 21 of motor generator MG1. Ring gear R2 may be coupled to a counter drive gear 51. Counter drive gear 51 can be an output gear of power split device PG, rotating together with ring gear R2.

It should be understood that the rotation speed of sun gear S2 (i.e., the rotation speed of motor generator MG1), the rotation speed of carrier CA2, and the rotation speed of ring gear R2 satisfy a linear relationship collinearly (i.e., once any two of the rotation speeds are determined, the last rotation speed is also determined). Therefore, by adjusting the rotation speed of motor generator MG1, it is possible to alter the ratio between the rotation speed of ring gear R2 and the rotation speed of carrier CA2 continuously.

Counter shaft (output shaft) 70 may be provided with a counter drive gear 71 and a differential drive gear 72. Counter drive gear 71 meshes with counter drive gear 51 of power split device PG. Thus, power from engine 10 and motor generator MG1 can be transmitted to counter shaft (output shaft) 70 via counter drive gear 51 of power split device PG.

Power split device PG may be connected to a point in a power transmission path from engine 10 to counter shaft (output shaft) 70. Therefore, after the rotation of engine 10 is gear-shifted in power split device PG, it can be transmitted to counter shaft (output shaft) 70.

Counter drive gear 71 meshes with a reduction gear 32 coupled to rotation shaft 31 of motor generator MG2. In this way, the power of motor generator MG2 can be transmitted to counter shaft (output shaft) 70 via reduction gear 32.

Differential drive gear 72 meshes with a differential ring gear 81 disposed in differential gear system 80. Differential gear system 80 may be coupled to right and left drive wheels 90 through right and left drive shafts 82, respectively. In other words, the rotation of counter shaft (output shaft) 70 can be transmitted to the right and left drive shafts 82 through differential gear system 80.

In HEV 2, crank shaft 11 of engine 10 is provided with a one-way clutch (OWC). One-way clutch OWC prevents the reverse rotation of engine 10. Thus, when a driver intends to move the vehicle rearward, with the help of one-way clutch OWC, the vehicle can be moved rearward simply by reversely rotating motor generator MG2 without performing any control on engine 10 and motor generator MG1.

The example vehicle illustrated by FIG. 2 is provided for illustration purposes only as one example of a vehicle system with which embodiments of the disclosed technology may be implemented. One of ordinary skill in the art reading this description will understand how the disclosed embodiments can be implemented with other vehicle platforms.

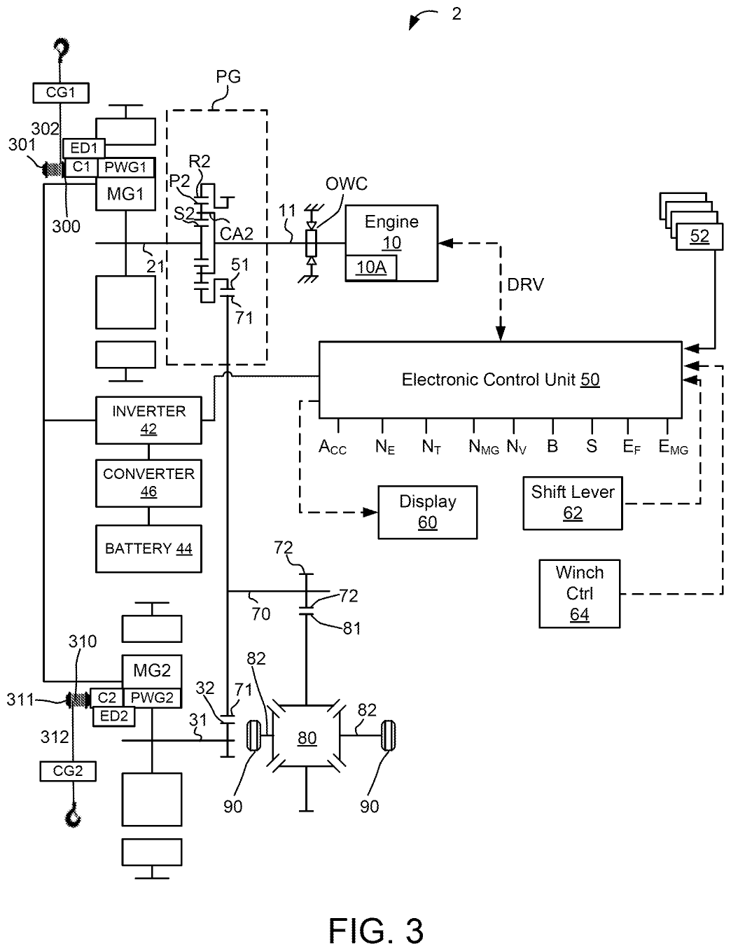

As noted above, embodiments of the present disclosure are directed to an integrated winch that uses an existing motor for power. FIG. 3 is schematic representation of an integrated winch system in accordance with some embodiments. A winch 300 may include a rotating member (e.g., spool or similar mechanism) 301 for extracting/retracting cable 302. Cable 302 can be routed through a cable guide CG1. Cable guide CG1 may comprise any known or later developed structure through which cable 302 can be extracted/retracted. The size or shape of cable guide CG1 can vary, but generally may be shaped/sized so as to control the movement of cable 302 relative to side/up/down loads. Moreover, cable 302 can be made to generally pull at a center location of cable guide CG1/rotating member 301 to evenly distribute such loads.

As described above, an existing motor of an HEV/EV can be leveraged to power a winch in accordance with embodiments of the present disclosure. In the example of FIG. 3, winch 300 may be powered by MG1 of vehicle 2. Because MG1 is typically used to provide motive force/power to propel vehicle 2, an additional clutch/planetary gear mechanism including a clutch C1 and a power split device PWG1 is used to operatively connect winch 300 to MG1 and control its operation. Disengagement of clutch C1 allows rotating member 301 to rotate freely so that cable 302 can be released or pulled from rotating member 301 for use. Disengagement of clutch C1 further, operatively disconnects winch 300 from MG1, thereby returning MG1 to its role of providing motive force for vehicle 2. Engagement of clutch C1 engages PWG1 so that MG1 can be used to power winch 300, e.g., to retrieve cable 302 (after being released and pulled out/away from rotating member 301). Clutch C1 can refer to any appropriate device known to those of ordinary skill in the art (or later developed) that engages and disengages a power transmission. Examples of clutches may include, but are not limited to dry clutches, wet clutches, centrifugal clutches, etc. In accordance with various embodiments, when engaged, clutch C1 transmits torque from MG1 to winch 300 (in particular rotating member 301) via PWG1, which allows winch 300 to retract cable 302. Operation of power split device PWG1 allows speed to also be varied in accordance with user desires/needs. In some embodiments, power split device PWG1 may be the same or similar to power split device PG.

In some embodiments, an additional winch, e.g., winch 310, can be integrated with vehicle 2. It should be understood that some users may have a need for a winch implemented at the rear of a vehicle, or some other location thereon or therein. Because vehicle 2 has another MG, i.e., MG2, winch 310 may be operatively connected to MG2 to provide enhanced utility for a user of vehicle 2. Similar to winch 300, winch 310 may include a rotating member 311 for extracting/retracting cable 312. Cable 312 can be routed through a cable guide CG2. Cable guide CG2 may comprise any known or later developed structure through which cable 312 can be extracted/retracted. The size or shape of cable guide CG2 can vary, but generally may be shaped/sized so as to control the movement of cable 312 relative to side/up/down loads. Moreover, cable 312 can be made to generally pull at a center location of cable guide CG2/rotating member 311 to evenly distribute such loads.

Because MG2 is typically used to provide motive force/power to propel vehicle 2, an additional clutch/planetary gear mechanism including a clutch C2 and a power split device PWG2 is used to operatively connect winch 310 to MG2 and control its operation. Engagement of clutch C2 allows MG2 to power winch 310. Disengagement of clutch C2 operatively disconnects winch 310 from MG2, thereby returning MG2 to its role of providing motive force for vehicle 2. In some embodiments, power split device PWG2 may be the same or similar to power split device PG, and may be used to control the speed winch 310.

Like clutch C1, disengagement of clutch C2 allows rotating member 311 to rotate freely so that cable 312 can be released or pulled from rotating member 311 for use. Disengagement of clutch C1 further, operatively disconnects winch 310 from MG1, thereby returning MG1 to its role of providing motive force for vehicle 2. Engagement of clutch C2 engages PWG2 so that MG2 can be used to power winch 310, e.g., to retrieve cable 312 (after being released and pulled out/away from rotating member 311). Clutch C2 can refer to any appropriate device known to those of ordinary skill in the art (or later developed) that engages and disengages a power transmission. Examples of clutches may include, but are not limited to dry clutches, wet clutches, centrifugal clutches, etc. In accordance with various embodiments, when engaged, clutch C2 transmits torque from MG2 to winch 310 (in particular rotating member 311) via PWG2, which allows winch 310 to retract cable 312. Operation of power split device PWG2 allows speed to also be varied in accordance with user desires/needs. In some embodiments, power split device PWG2 may be the same or similar to power split device PG.

It should be understood that power split devices PWG1/PWG2 may connect rigidly to one or more structures of vehicle 2, e.g., the frame of vehicle 2, in order to support the loads applied to winch 300/310. Moreover, the motors of HEVs/EVs, such as MG1 and MG2 tend to be more centrally located in vehicle 2, or at least tend to be located more neutrally than where the electric motors of conventional winches are located. Thus, handling of vehicle 2 is impacted less by the integration of winch 300/310 compared to the integration of conventional winches on vehicles (as described above). Additionally still, there is no disruption to the energy absorbing components at the front/rear (or anywhere) of vehicle 2.

As noted above, vehicle 2 may include one or more sensors 52. In addition to the examples described above, sensors 52 may further include one or more sensors that monitor use/operation of winch 300/310. For example, such sensors may monitor whether or not winch 300/310 is engaged for use by clutch C1/PWG1 and C2/PWG2, respectively. Other aspects of winch 300/301 that may be of interest to a user or relevant to operation of winch 300/301 may be monitored/sensed, and provided to ECU 50.

Additionally, to control user/operation of winch 300/310, a winch control component 64 may be implemented in vehicle 2. Winch control component 64 may comprise one or more switches or actuators for actuating/controlling winch 300/310 (or may provide an interface for actuating/controlling winch 300/310). For example, sensors 52 may include sensors that can monitor the speed of rotation of rotating members 301/311, and winch control 64 may include an interface or interactive elements for controlling the speed of rotation of rotating members 301/311. Moreover, given the above-described sensors 52, winch control 64 may also include an interface or display/presentation mechanism (lights, screen, or other indicators) that present the operational status of winch 300/310 to a user.

Further regarding clutches C1/C2, engagement and disengagement of clutches C1 and C2 may be effectuated using manual or automated/electric engagement/disengagement mechanism (ED1 and ED2). For example, such a mechanism can be a manual handle that, e.g., rotates or turns to engage/disengage PWG1 and PWG2 respectively. Alternatively, there can be some other manual mechanism, such as rods or other push/pull mechanisms that operatively attach to clutches C1 and C2, respectively, e.g., at the front of the vehicle, under the vehicle hood, etc. that operate to engage or disengage clutches C1 and C2 from PWG1 and PWG2, respectively. Further still, in some embodiments, clutches C1/C2 can be engaged/disengaged through an electric servo that is activated by, e.g., push button, or other control switch/component located on/in vehicle 2, or even on a key fob, or other device, such as wing control component 64 (described above) that can be used to remotely control the ED mechanism(s) ED1/ED2.

Regarding winch control 64, it should be understood that above-described interfaces or functionality can be implemented in one or more components located within or on vehicle 2, e.g., in-dash componentry. In other embodiments, winch control 64 may comprise a separate, but tethered control, such as a tethered remote control communicatively connected to ECU 50 through a wired link or connection. In still other embodiments, winch control 64 may be a remote control that communicatively connects to ECU 50 via wireless communication mechanisms, e.g., Bluetooth or WiFi. It should be understood that both ECU 50 and winch control 64 have appropriate wired/wireless communication components (e.g., wired/wireless transmitters and receivers) for transmitting and receiving control signals.

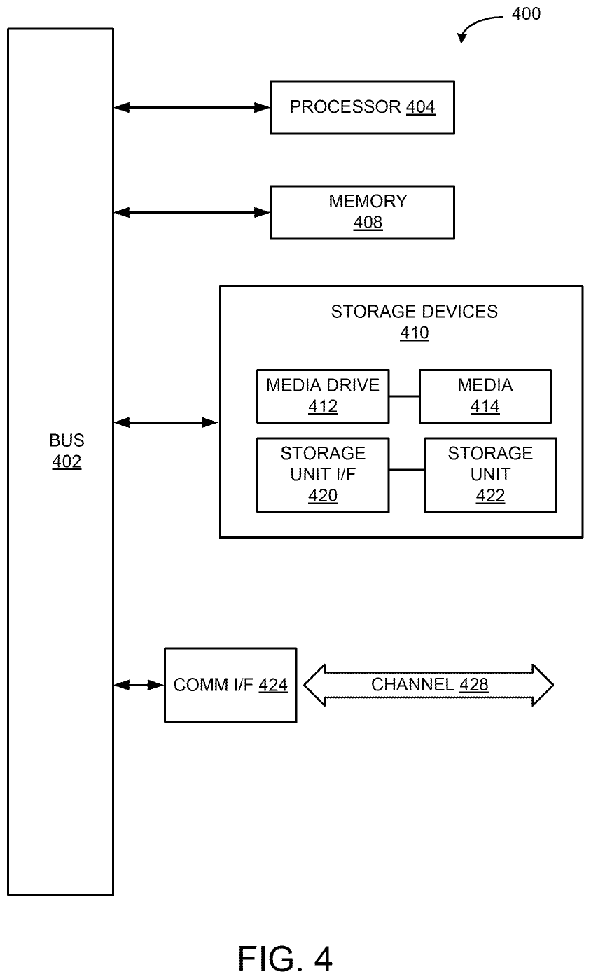

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 4. Various embodiments are described in terms of this example-computing component 400. After reading this description, it will become apparent to a person skilled in the relevant art how to implement the application using other computing components or architectures.

Referring now to FIG. 4, computing component 400 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 400 might also represent computing capabilities embedded within or otherwise available to a given device. For example, a computing component might be found in other electronic devices such as, for example, portable computing devices, and other electronic devices that might include some form of processing capability.

Computing component 400 might include, for example, one or more processors, controllers, control components, or other processing devices. This can include a processor 404. Processor 404 might be implemented using a general-purpose or special-purpose processing engine such as, for example, a microprocessor, controller, or other control logic, such as ECU 50 or winch control component 64. Processor 404 may be connected to a bus 402. However, any communication medium can be used to facilitate interaction with other components of computing component 400 or to communicate externally.

Computing component 400 might also include one or more memory components, simply referred to herein as main memory 408. For example, random access memory (RAM) or other dynamic memory, might be used for storing information and instructions to be executed by processor 404. Main memory 408 might also be used for storing temporary variables or other intermediate information during execution of instructions to be executed by processor 404. Computing component 400 might likewise include a read only memory (“ROM”) or other static storage device coupled to bus 402 for storing static information and instructions for processor 404.

The computing component 400 might also include one or more various forms of information storage mechanism 410, which might include, for example, a media drive 412 and a storage unit interface 420. The media drive 412 might include a drive or other mechanism to support fixed or removable storage media 414. For example, a hard disk drive, a solid-state drive, a magnetic tape drive, an optical drive, a compact disc (CD) or digital video disc (DVD) drive (R or RW), or other removable or fixed media drive might be provided. Storage media 414 might include, for example, a hard disk, an integrated circuit assembly, magnetic tape, cartridge, optical disk, a CD or DVD. Storage media 414 may be any other fixed or removable medium that is read by, written to or accessed by media drive 412. As these examples illustrate, the storage media 414 can include a computer usable storage medium having stored therein computer software or data.

In alternative embodiments, information storage mechanism 410 might include other similar instrumentalities for allowing computer programs or other instructions or data to be loaded into computing component 400. Such instrumentalities might include, for example, a fixed or removable storage unit 422 and an interface 420. Examples of such storage units 422 and interfaces 420 can include a program cartridge and cartridge interface, a removable memory (for example, a flash memory or other removable memory component) and memory slot. Other examples may include a PCMCIA slot and card, and other fixed or removable storage units 422 and interfaces 420 that allow software and data to be transferred from storage unit 422 to computing component 400.

Computing component 400 might also include a communications interface 424. Communications interface 424 might be used to allow software and data to be transferred between computing component 400 and external devices. Examples of communications interface 424 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 424 may be carried on signals, which can be electronic, electromagnetic (which includes optical) or other signals capable of being exchanged by a given communications interface 424. These signals might be provided to communications interface 424 via a channel 428. Channel 428 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 408, storage unit 420, media 414, and channel 428. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 400 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A vehicle comprising:
a motor generator;
a clutch;
a power split device; and
a winch connected to the motor generator via the clutch and the power split device, the clutch being operative to selectively engage or disengage the winch assembly from the motor generator, and the power split device being operative to control speed of operation of the winch.

2. The vehicle of claim 1, wherein the power split device comprises a planetary gear.

3. The vehicle of claim 1, further comprising a winch control component operative to control the selective engagement or disengagement of the clutch.

4. The vehicle of claim 3, wherein the winch control component is further operative to receive user input directing the operation of the power split device to control the speed of operation of the winch.

5. The vehicle of claim 4, wherein the winch comprises a rotating member to which a cable is connected, the rotating member effectuating the directed operation of the power split device.

6. The vehicle of claim 5, further comprising a cable guide through which the cable operatively connected to the rotating member is routed.

7. The vehicle of claim 1, further comprising:
a second motor generator,
a second clutch;
a second power split device; and
a second winch connected to the second motor generator via the second clutch and the second power split device, the second clutch being operative to selectively engage or disengage the second winch assembly from the second motor generator, and the second power split device being operative to control speed of operation of the second winch.

8. The vehicle of claim 7, wherein the second power split device comprises a second planetary gear.

9. The vehicle of claim 7, wherein the winch control component is operative to control the selective engagement or disengagement of the second clutch.

10. The vehicle of claim 9, wherein the winch control component is further operative to receive additional user input directing the operation of the second power split device to control the speed of operation of the second winch.

11. The vehicle of claim 7, wherein the second winch comprises a second rotating member to which a second cable is connected, the second rotating member effectuating the directed operation of the second power split device.

12. The vehicle of claim 11, further comprising a second cable guide through which the second cable operatively connected to the rotating member is routed.
